(19) United States
(12) Patent Application Publication
(10) Pub. No.: US 2002/0154872 A1
(43) Pub. Date: Oct. 24, 2002

(54) Protective member and optical module

(75) Inventor: Jun Miyokawa, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/124,416

(22) Filed: Apr. 18, 2002

(30) Foreign Application Priority Data
Apr. 20, 2001 (JP) 2001-122742

(51) Int. Cl. G02B 6/42

(52) U.S. Cl. 385/92; 385/88

(57) ABSTRACT

A protective member and an optical module comprises a package for retaining an optical component, an optical fiber to be fixed to the package in such a way as to be optically coupled to the optical component and a protective member which protects the optical fiber. The protective member has a body, which covers the package and optical fiber, formed of an elastic material and a reinforcing member arranged along an inner surface of the body to cover an outer surface of the optical fiber in a contactless state with respect to the optical fiber.

### FIELD OF THE INVENTION

The present invention relates to a protective member and an optical module.

### BACKGROUND OF THE INVENTION

In an optical module which retains an optical component in a package, such as a semiconductor laser module, a rubber boot is provided at that portion where an optical fiber used for inputting and outputting optical signals extends from the package to protect the optical fiber against a handling-originated damage, such as breakage.

There may be an event that due to miss handling an optical module, stress is applied to the optical fiber in a direction perpendicular to the longitudinal direction of the optical fiber. In such an event, if the optical fiber extends from the package via a ferrule, the applied bending stress bends the optical fiber hard at that extended portion, so that the radius of curvature of the optical fiber becomes extremely small and the optical fiber may be broken.

If such breakage of the optical fiber occurs, the tensile stress resistance of the optical fiber is lower than the standard specification of the product. The breakage of the optical fiber causes another problem that a predetermined optical characteristic cannot be obtained using the optical fiber. The reduction in tensile stress resistance or the inability to acquire a predetermined optical characteristic are critical issues particularly for an optical module that is used in an optical fiber amplifier or the like for a submarine cable whose specification-requirements and reliability performances are very tight.

### SUMMARY OF THE INVENTION

It is an object of the present invention to provide a protective member for reducing an amount of bending stress on an optical fiber that protrudes from an exit portion of a package of an optical module.

It is another object of the present invention to provide an optical module which has an improved protection for an optical fiber that protrudes from an exit portion of a package of the optical module.

To achieve the first object, the protective member comprises a hollow body formed of an elastic material and having a first open end, a second open end, a reinforced hollow portion and an unreinforced hollow portion, the first open end configured to be fitted about the exit portion of the package such that the optical fiber extends through the reinforced hollow portion and unreinforced hollow portion, and exits through the second open end; and a reinforcing member disposed within the reinforced hollow portion of the hollow body and configured to reduce an amount of flexure of the reinforced hollow portion when an external force is applied in a direction orthogonal to a longitudinal axis thereof, wherein the second open end being in contact with and coaxially disposed about the optical fiber.

To achieve the second object, an optical module according to the present invention comprises a package configured to retain an optical component therein, having an exit portion thereof; an optical fiber having a first portion fixed to the package so as to be optically coupled to the optical component and a second portion that extends outside of the package; and a protective member that includes a hollow body formed of an elastic material and having a first open end, a second open end, a reinforced hollow portion and an unreinforced hollow portion, the first open end configured to be fitted about the exit portion of the package such that the optical fiber extends through the reinforced hollow portion and unreinforced hollow portion, and exits through the second open end, wherein the second open end being in contact with and coaxially disposed about the optical fiber, and a reinforcing member disposed within the reinforced hollow portion of the hollow body and configured to reduce an amount of flexure of the reinforced hollow portion when an external force is applied in a direction orthogonal to a longitudinal axis thereof

The aforementioned object and other objects, features and advantages of the present invention will become more apparent from the detailed description given hereinafter with reference to the accompanying drawings.

### BRIEF DESCRIPTION OF THE DRAWINGS

FIG. 1 is a cross-sectional view of a semiconductor laser module attached with a protective member, which illustrates the protective member and an optical module according to one embodiment of the present invention;

FIG. 2 is a cross-sectional view showing a state in which the protective member in FIG. 1 is assembled;

FIG. 3 is a cross-sectional view of the assembled protective member;

FIG. 4 is a cross-sectional view illustrating essential portions in enlargement when stress is applied to the protective member of the optical module in FIG. 1;

FIG. 5 is an enlarged cross-sectional view of a portion A in FIG. 4;

FIG. 6 is a cross-sectional view showing a protective member according to another embodiment;

FIG. 7 is a cross-sectional view showing a modification of the optical module; and

FIG. 8 is a cross-sectional view depicting a protective member and an optical module according to a further embodiment of the present invention.

### DETAILED DESCRIPTION

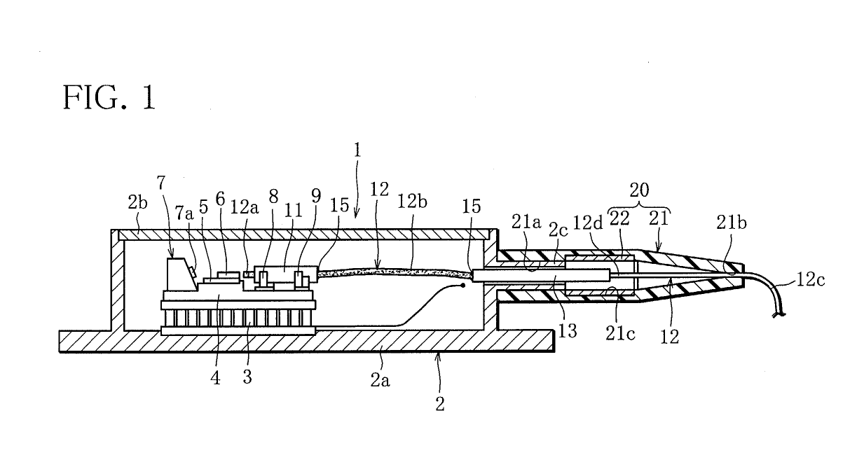

A protective member and an optical module according to one embodiment of the present invention will now be described referring to FIGS. 1 through 8.

A semiconductor laser module 1 has a Peltier module 3 disposed in a metal package 2 and a base 4 placed on the Peltier module 3, as shown in FIG. 1.

As shown in FIG. 1, the package 2 has a body 2a, a lid 2b and a cylindrical portion 2c protruding from the body 2a. The cylindrical portion 2c is formed integrally with the body 2a. The cylindrical portion 2c fixes an optical fiber 12 to be discussed later to the package 2 via a second ferrule 13.

A semiconductor laser device 6 is provided on the top surface of the base 4 via a heat sink 5. A monitor photodiode 7a is provided on a carrier 7 on one side of the base 4 and a first ferrule 11 is provided on the other side via ferrule holders 8 and 9.

The first ferrule 11 has a distal end at which the optical fiber 12 is inserted, secured, and protruding toward the semiconductor laser device 6. The optical fiber 12 has a lens portion 12a formed at its distal end, and its distal-end side surface is coated with a metal plating 12b of Au or the like. The lens portion 12a of the optical fiber 12 is arranged facing to and aligned with the semiconductor laser device 6, and the other end of the optical fiber 12 is drawn out of the cylindrical portion 2c formed on the package 2. The metal second ferrule 13 is attached to that portion of the optical fiber 12 which corresponds to the cylindrical portion 2c. The optical fiber 12 is secured to the first ferrule 11 and the second ferrule 13 at the distal end of the ferrule 11, 13 by a solder 15 of Au—Sn. The second ferrule 13 is fixed to the cylindrical portion 2c by soldering, welding, an adhesive, synthetic resin or a composite member or the like of an adhesive and synthetic resin.

The portion of the optical fiber 12 that extends from the second ferrule 13 is a bending allowance portion 12c which can bend to some degree (see FIG. 5).

The package 2 has a protective boot 20 for protecting the extending optical fiber 12. The protective boot 20 is fitted over the cylindrical portion 2c.

The protective boot 20 has a body 21 and a cylindrical reinforcing member 22 shown in FIGS. 1 through 3.

The body 21 is made of an elastic member, such as silicone-based nonflammable rubber, and formed into a cylinder which has openings 21a and 21b at the front and rear portion and becomes narrower rearward in a tapered shape. Formed in the inner surface of the body 21 is a recess portion 21c in which the reinforcing member 22 is to be fitted. The body 21 is formed in such a way that the inner shape of the end portion of the body 21 lying on the cylindrical portion (2c) side has a shape approximately identical to the outer shape of the cylindrical portion 2c. As the body 21 is fitted over the cylindrical portion 2c, the end portion firmly contact the outer surface of the cylindrical portion 2c by the elastic force and covers the cylindrical portion 2c, the second ferrule 13 and the bending allowance portion 12c of the optical fiber 12. The recess portion 21c is formed in such a way that as shown in FIGS. 1 and 5, when the reinforcing member 22 is fitted in the recess portion 21c, the reinforcing member 22 is placed at such a position as to cover at least the rear portion of the second ferrule 13 and a start end portion 12d of the bending allowance portion 12c of the optical fiber 12.

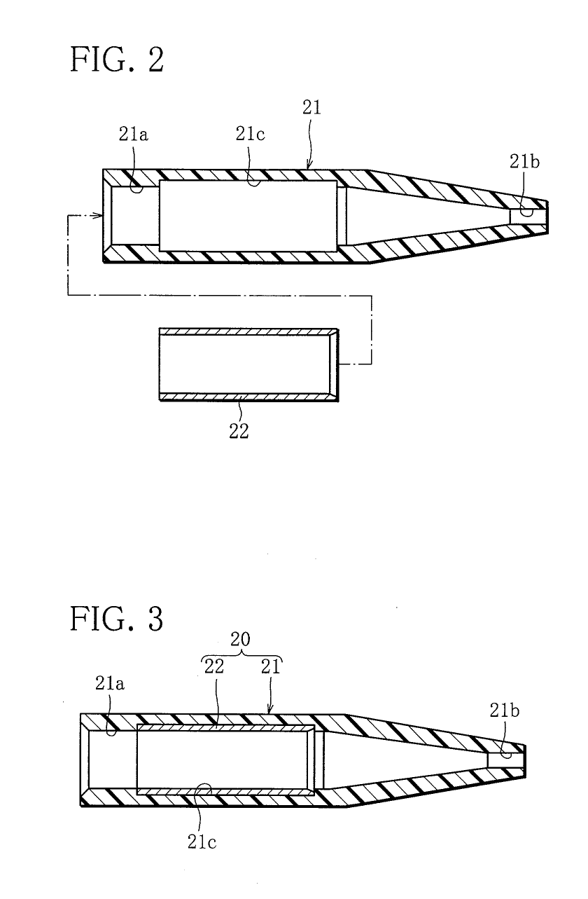

The reinforcing member 22 is formed of a metal, such as aluminum, engineering plastic, such as polyphenylene sulfide (PPS), phenolic resin or glass epoxy resin, or ceramic, such as zirconia, into a cylindrical shape. As shown in FIG. 2, the reinforcing member 22 is led into the body 21 through the opening side 21a and fitted into the recess portion 21c. The inside diameter of the reinforcing member 22 is set larger than the outside diameter of the second ferrule 13.

The optical fiber 12, the second ferrule 13, the reinforcing member 22, the cylindrical portion 2c and the body 21 of the protective boot 20 are arranged concentrically with the optical fiber 12 as the center as seen from their cross sections perpendicular to the longitudinal direction of the optical fiber 12. While it is desirable that the reinforcing member 22 is integrated, it may approximately have the shape of the alphabet C partially having a cut as seen from the end face, or may be a combination of multiple parts divided along with the center axis of the cylinder.

In case where a connector which is hard to pass through the opening 21b is attached to the end portion of the optical fiber 12 of the semiconductor laser module 1 with the above-described structure, the protective boot 20 is put over the optical fiber 12 in advance, then the first ferrule 11 and second ferrule 13 are attached to a predetermined position of the optical fiber 12.

Next, the Peltier module 3 is placed in the body 2a of the package 2, and the base 4 provided with the components from the heatsink 5 to the ferrule holders 8 and 9 is set in the body 2a.

Then, the optical fiber 12 with the first ferrule 11 and second ferrule 13 attached thereto is led into the package 2 from the cylindrical portion 2c and the first ferrule 11 is fixed to the ferrule holders 8 and 9 with the lens portion 12a at the distal end aligned with the semiconductor laser device 6.

Then, the second ferrule 13 is fixed to the cylindrical portion 2c as mentioned above, and the protective boot 20 is moved along the optical fiber 12 to be fitted over the cylindrical portion 2c. Then, the lid 2b is attached to the body 2a by soldering, YAG laser welding or the like, thus completing the assembly of the semiconductor laser module 1 with the package 2 sealed airtight.

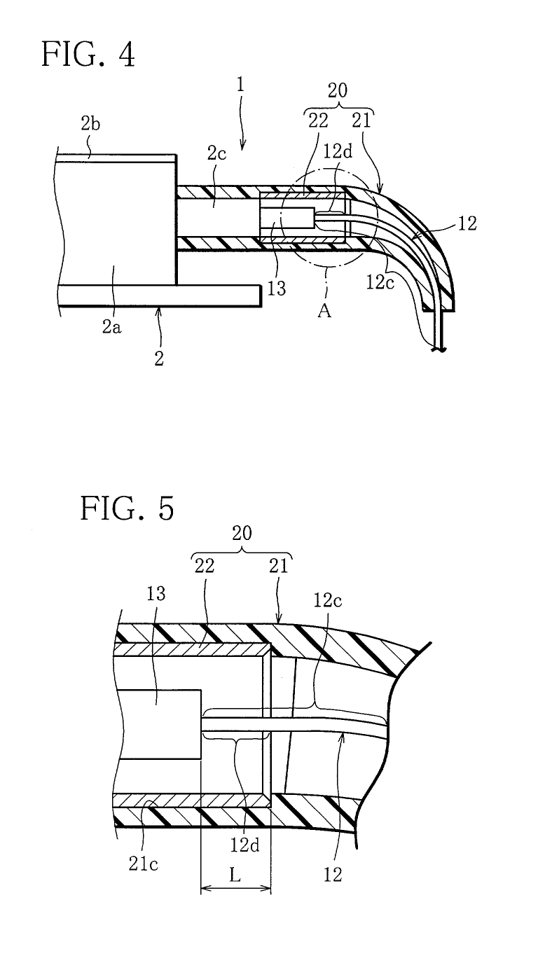

As shown in FIG. 4, bending stress may be applied to the bending allowance portion 12c of the optical fiber 12 when the semiconductor laser module 1 fabricated in the above-described manner is handled. Even with the bending stress applied, the action of the protective boot 20 can restrain the optical fiber 12 from being broken. This will be discussed below specifically.

The protective boot 20 is fitted over the cylindrical portion 2c of the package 2 of the semiconductor laser module 1. As the reinforcing member 22 is placed in the body 21 of the protective boot 20, as shown in FIG. 5, the reinforcing member 22 covers the optical fiber 12 by a predetermined length L (e.g., a length nearly equivalent to the diameter of the second ferrule 13) with respect to the longitudinal direction of the optical fiber 12 in the diagram over the outer surface of the start end portion 12d of the bending allowance portion 12c of the optical fiber 12 extending from the second ferrule 13. What is more, as the inside diameter of the reinforcing member 22 is larger than the outside diameter of the second ferrule 13, the reinforcing member 22 does not contact the optical fiber 12.

Even if bending stress is applied to the optical fiber 12, therefore, bending stress does not act on the start end portion 12d of the bending allowance portion 12c of the optical fiber 12 and the start end portion 12d is held straight. Therefore, the radius of curvature of the optical fiber 12 is prevented from becoming extremely smaller and the optical fiber 12 is protected against breakage.

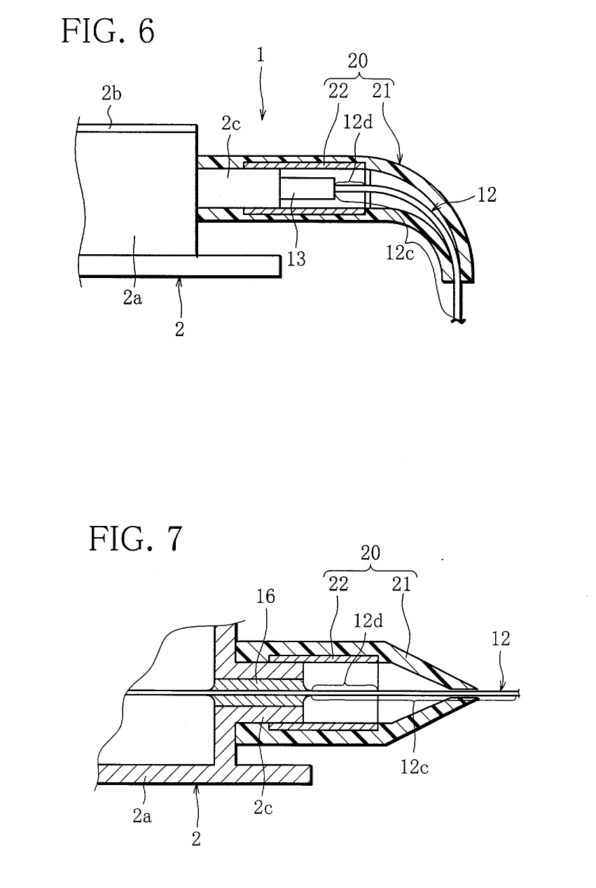

The protective boot 20 may be designed in such a way that as shown in FIG. 6, the reinforcing member 22 placed in the body 21 is made longer to extend to the cylindrical portion 2c. With this structure, the reinforcing member 22 of the protective boot 20 covers around the outer surface of the cylindrical portion 2c in addition to the end portion of the body 21. This stabilizes the fixing position of the reinforcing member 22, rather than the semiconductor laser module 1 shown in FIGS. 1 to 4. Also, this makes the laser module more resistive to the applied bending stress and facilitates the fitting of the protective boot 20, which is preferable. As a result, the function of the protective boot 20 to protect the optical fiber 12 extending from the second ferrule 13 is enhanced further At this time, the protective boot 20 and reinforcing member 22 may be securely adhered to the cylindrical portion 2c by an adhesive or synthetic resin.

The semiconductor laser module 1 is likewise protected by the protective boot 20 even if the optical fiber 12 is directly fixed to the cylindrical portion 2c in an airtight fashion by, for example, a solder 16 of Au—Sn or the like without using the second ferrule 13 as shown in FIG. 7.

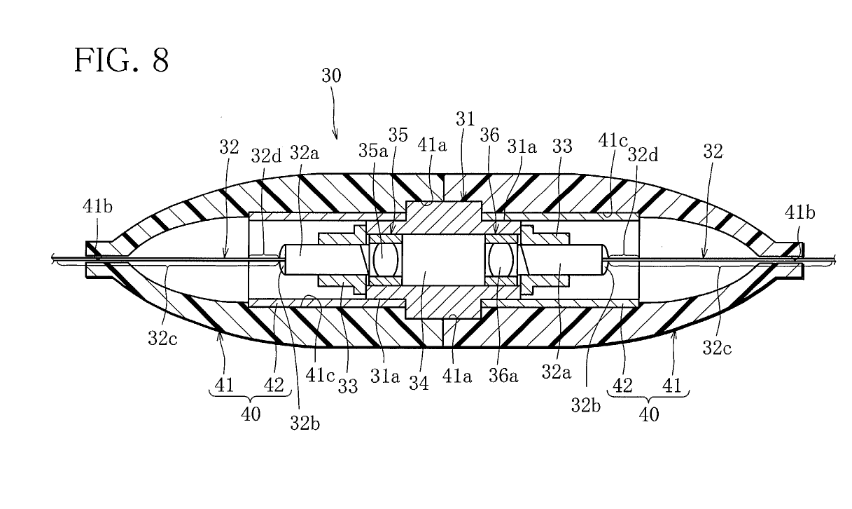

A protective member and an optical module according to another embodiment of the present invention will be discussed below in detail by referring to FIG. 8.

An optical module 30 has a package 31, an optical fiber 32 inserted in ferrules 32a, slide rings 33 and a protective boot 40, as shown in FIG. 8.

As illustrated, the package 31 is a cylindrical member which holds an optical isolator 34 and lens holders 35 and 36 and has steps 31a formed on the outer surface of the respective ends. The lens holders 35 and 36 hold lenses 35a and 36a, respectively.

The optical fiber 32 is fixed to the slide rings 33 secured to the respective sides of the package 31, via the ferrules 32a by YAG welding. To reduce reflection of lights which have been transmitted from the lenses 35a and 36a, the end faces of the ferrules 32a that face the lens holders 35 and 36 are formed obliquely with respect to the optical axis and the rear portion from which the optical fiber 32 extends is sealed with an adhesive 32b.

The slide rings 33 are cylindrical portions that fix the optical fiber 32 to the package 31 via the ferrules 32a, and are fixed to the respective sides of the package 31 by YAG welding.

The protective boot 40 has a body 41 and a reinforcing pipe 42 which are formed by the same materials as those of the protective boot 20. To avoid a detailed description of the protective boot 40, therefore, like reference numerals are used for the constituting portions of the protective boot 40 in FIG. 8 which correspond to those of the protective boot 20.

As mentioned above, the optical fiber 32 of the optical module 30 is fixed to the slide rings 33 fixed to the respective sides of the package 31 via the respective ferrules 32a. The reinforcing pipe 42 is placed in the body 41 of the protective boot 40. Even if bending stress is applied to the optical fiber 32 due to the handling-originated stress acting on the optical fiber 32, therefore, the portion of the optical fiber 32 that extends from the ferrules 32a, i.e., a start end portion 32d of a bending allowance portion 32c, is held straight, thus preventing the optical fiber 32 from being broken.

The foregoing description of the embodiment has been given of an optical module which has a semiconductor laser or an optical isolator retained in the package. The optical component to be retained in the package of the optical module of the present invention is not however limited to that particular type.

Needless to say, the package, the cylindrical portion and the body and reinforcing member of the protective boot can take arbitrary cross-sectional shapes, such as a circle, a polygon, such as a rectangle.

Further, the protective boot may be adhered to the package by an adhesive or synthetic resin in the embodiments.

Furthermore, the optical fiber may be of any type, such as a single mode fiber, a multi-mode fiber or a polarization-maintaining fiber.

What is claimed is:

1. A protective member for reducing an amount of bending stress on an optical fiber that protrudes from an exit portion of a package of an optical module, comprising:
a hollow body formed of an elastic material and having a first open end, a second open end, a reinforced hollow portion and an unreinforced hollow portion, said first open end configured to be fitted about the exit portion of said package such that said optical fiber extends through the reinforced hollow portion and unreinforced hollow portion, and exits through said second open end; and
a reinforcing member disposed within the reinforced hollow portion of said hollow body and configured to reduce an amount of flexure of the reinforced hollow portion when an external force is applied in a direction orthogonal to a longitudinal axis thereof, wherein
said second open end being in contact with and coaxially disposed about said optical fiber.

2. The protective member according to claim 1, wherein:
said hollow body and said reinforcing member each having a cylindrical shape.

3. The protective member according to claim 2, wherein:
said hollow body having an inner surface with a recess portion; and
said reinforcing member being disposed in said recess portion of said hollow body.

4. An optical module comprising:
a package configured to retain an optical component therein, having an exit portion thereof;
an optical fiber having a first portion fixed to said package so as to be optically coupled to said optical component and a second portion that extends outside of said package; and
a protective member that includes
a hollow body formed of an elastic material and having a first open end, a second open end, a reinforced hollow portion and an unreinforced hollow portion, said first open end configured to be fitted about the exit portion of said package such that said optical fiber extends through the reinforced hollow portion and unreinforced hollow portion, and exits through said second open end, wherein said second open end being in contact with and coaxially disposed about said optical fiber, and
a reinforcing member disposed within the reinforced hollow portion of said hollow body and configured to reduce an amount of flexure of the reinforced hollow portion when an external force is applied in a direction orthogonal to a longitudinal axis thereof.

5. The optical module according to claim 4, wherein:
said reinforcing member is configured to cover an outer surface of a start of a bending allowance portion of said optical fiber by a predetermined length in a longitudinal direction of said optical fiber.

6. The optical module according to claim 4, wherein:
said exit portion of said package is formed as a cylindrical portion through which said optical fiber extends and is secured; and
said first open end of said protective member being fitted about an outer surface of said cylindrical portion.

7. The optical module according to claim 5, wherein:
said exit portion of said package is formed as a cylindrical portion through which said optical fiber extends and is secured; and
said first open end of said protective member being fitted about an outer surface of
said cylindrical portion.

8. The optical module according to claim 4, wherein:
said optical component includes a semiconductor laser.

9. The optical module according to claim 5, wherein:
said optical component includes a semiconductor laser.

10. The optical module according to claim 6, wherein:
said optical component includes a semiconductor laser.

11. The optical module according to claim 7, wherein:
said optical component includes a semiconductor laser.

12. The optical module according to claim 4, wherein:
said optical component includes an optical isolator.

13. The optical module according to claim 5, wherein:
said optical component includes an optical isolator.

14. The optical module according to claim 6, wherein:
said optical component includes an optical isolator.

15. The optical module according to claim 7, wherein:
said optical component includes an optical isolator.

16. A protective member for reducing an amount of bending stress on an optical fiber that protrudes from an exit portion of a package of an optical module, comprising:
a hollow body formed of an elastic material and having a first open end and a second open end, including
means for coupling said hollow body at said first open end to said exit portion of said package; and
means for reinforcing said hollow body toward said first open end, but not toward said second open end, including
means for holding said optical fiber straight within said hollow body toward said first open end, but enabling a restricted amount of bending toward said second open end of said optical fiber and said hollow body.

17. An optical module comprising:
a package configured to retain an optical component therein;
an optical fiber having a first portion fixed to said package so as to be optically coupled to said optical component and a second portion that extends outside of said package; and
a protective member that includes
a hollow body formed of an elastic material and having a first open end, a second open end, a reinforced hollow portion and an unreinforced hollow portion, said first open end configured to be fitted about the exit portion of said optical module such that said optical fiber extends through the reinforced hollow portion and unreinforced hollow portion, and exits through said second open end, wherein said second open end being in contact with and coaxially disposed about said optical fiber;
a reinforcing member disposed within the reinforced portion of said hollow portion of said hollow body and configured to reduce an amount of flexure of the reinforced hollow portion of said hollow body when an external force is applied in a direction orthogonal to a longitudinal axis of the hollow body;
means for coupling said hollow body at said first open end to said exit portion of said package; and
means for reinforcing said hollow body toward said first open end, but not toward said second open end, including
means for holding said optical fiber straight within said hollow body toward said first open end, but enabling a restricted amount of bending toward said second open end of said optical fiber and said hollow body.
